(19) United States
(12) Patent Application Publication
(10) Pub. No.: US 2004/0119221 A1
(43) Pub. Date: Jun. 24, 2004

(54) Free standing cutting board

(76) Inventor: Philip H. Davis, Mercersburg, PA (US)

Correspondence Address: JAMES RAY & ASSOCIATES, 2640 PITCAIRN ROAD, MONROEVILLE, PA, 15146, US

(21) Appl. No.: 10/324,292

(22) Filed: Dec. 19, 2002

(51) Int. Cl. B23Q 3/00

(52) U.S. Cl. 269/289 R

(57) ABSTRACT

A cutting board comprising a first member having a first predetermined shape and a predetermined thickness and formed from a predetermined material. The predetermined material having sufficient cut resistant properties and heat resistant properties for cutting at least one of hot and cold food products thereon and sufficient strength to support such food products to be cut. There is an upper surface of the first member that has a first predetermined size for holding such food products to be cut and a bottom surface that has a second predetermined size and a predetermined plurality of legs engageable with the first member adjacent the bottom surface for supporting the first member.

### CROSS REFERENCE TO RELATED APPLICATIONS

The invention taught in this patent application is closely related to the invention taught in the following co-pending patent application, CUTTING BOARD, Serial No. ______ which is being filed concurrently herewith. These patent applications are assigned to the same assignee and the teachings therein are incorporated into this application by reference thereto.

### FIELD OF THE INVENTION

The present invention relates, in general, to cutting boards for kitchen use and, more particularly, this invention relates to a cutting board wherein the cutting board is a free standing board that can be used with a drip pan or other such pans permitting the cutting to take place on top of the pan with any liquid draining into the pan.

### BACKGROUND OF THE INVENTION

Cutting boards have been used for many years to support the items to be cut and for providing a surface upon which the cutting can take place. Cutting boards have been made of wood and to some extent cut resistant plastic. For many years wood has been the preferred choice and it is only in recent times that plastic cutting boards have made an inroad on the wooden boards.

The cutting board routinely is placed on a table or counter top and the item to be cut is placed on the board. The item is cut with a knife which passes through the item till it reaches the cutting board. The board, therefore, provides protection for the table top or counter top and prevents the top from being marked up or cut during the cutting process.

One problem that occurs with cutting boards is that if the item being cut has juices then the liquid from the item, whether it be a roast, ham, turkey or whatever can drain off of the cutting board and drip onto the table top or counter top that supports the cutting board.

### SUMMARY OF THE INVENTION

The present invention, therefore, provides a cutting board comprising a first member having a first predetermined shape and a predetermined thickness and formed from a predetermined material. The predetermined material having sufficient cut resistant properties and heat resistant properties for cutting at least one of hot and cold food products thereon and sufficient strength to support such food products to be cut.

There is an upper surface of the first member that has a first predetermined size for holding such food products to be cut and a bottom surface that has a second predetermined size and a predetermined plurality of legs engageable with the first member adjacent the bottom surface for supporting the first member.

### OBJECTS OF THE INVENTION

It is, therefore, one of the primary objects of the invention to provide a cutting board which can be used as a free standing cutting board.

Another object of the present invention is to provide a cutting board that can be used at the table.

Still another object of the present invention is to provide a cutting board which can be used with a variety of drip trays.

Yet another object of the present invention is to provide a cutting board that has legs attached to the cutting board so as to support the board.

Another object of the present invention is to provide a cutting board in which the legs are detachable.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a top view of a free standing cutting board according to an embodiment of the invention.

FIG. 2 is perspective view of the top of the cutting board of FIG. 1 which shows the legs attached to the board.

FIG. 3 is a perspective view of the bottom of the cutting board shown in FIG. 1 with the legs attached.

FIG. 4 is a perspective view of the bottom of the cutting board with the legs detached according to an alternate embodiment of the invention.

FIG. 5 is a top view of a free standing cutting board according to an alternate embodiment of the invention.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

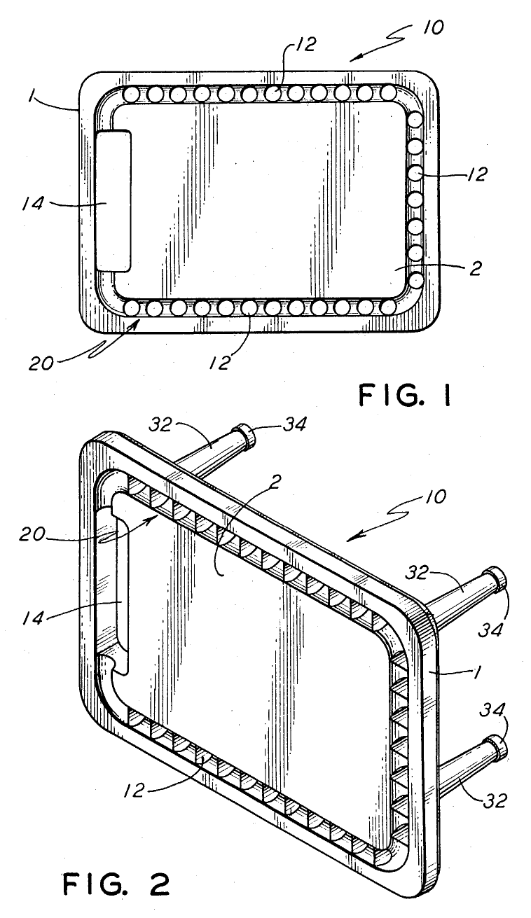

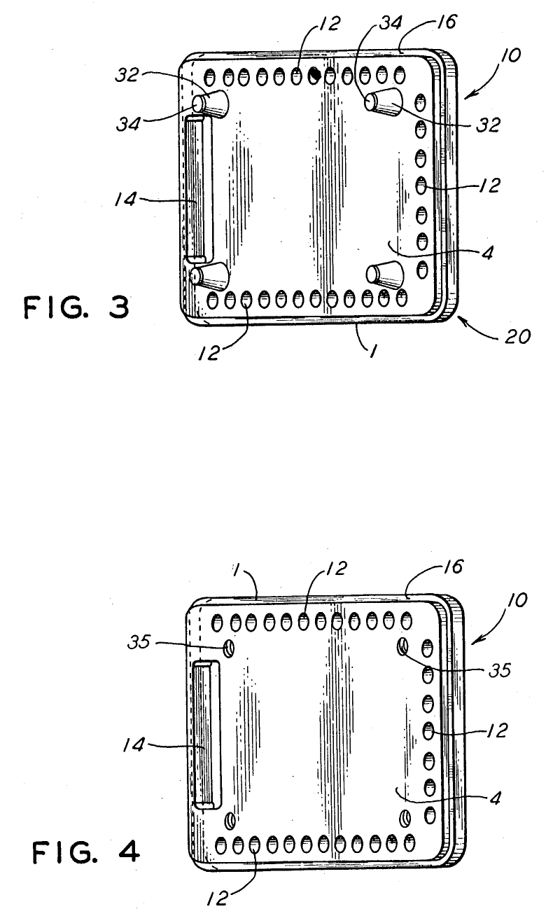

Illustrated in FIGS. 1-3 is a cutting board, generally designated 10, according to an embodiment of the invention. Such cutting board includes a first member 1 which has a top surface 2 and a bottom surface 4. Such first member is selected from a material having sufficient cut resistant properties and heat resistant properties for cutting both hot and cold food products and sufficient strength to support such food products to be cut. Such first member 1 is selected from a group including polypropylene, high density polyethylene and wood. Such wood further includes laminated or ingrained wood. It is presently preferred that such cutting board be polypropylene.

The drawings show the cutting board 10 as being rectangular; however, it is within the scope of the invention that such cutting board could be round, oval, square or rectangular. It is presently preferred that such cutting board be rectangular so as to fit into rectangular drip pans.

Such cutting board 10 further includes a predetermined plurality of legs 32 which are disposed on the bottom surface 4 of such first member 1. Such plurality of legs 32 are at least three. In a presently preferred embodiment of the invention such plurality of legs 32 are four. Further it is presently preferred that such legs 32 be disposed closely adjacent the four corners of the bottom surface 4 of such rectangular cutting board 10.

It is also presently preferred that such plurality of legs 32 further include a non-skid surface 34 on the unattached ends of the plurality of legs 32. It is also an embodiment of the invention that such non-skid surface 32 be formed as a cap over the ends of the legs 32. Further it is preferred that such non-skid surface 34 be made of a resilient material and that such resilient material be rubber.

In an alternate embodiment of the invention such legs 10 are detachable from the bottom surface 4 of such first member 1. In this embodiment such bottom surface 4 has threaded apertures 34 into which such legs 32, having threads on one end, can screw into threaded apertures 34 to hold the legs 32 in place. When the legs 32 are removed, the cutting board 10 can still be used by sitting the cutting board on the top of a drip pan (not shown) in which a lip 16 on the bottom surface 4 of such first member 1 can engage the walls of a drip pan and support the cutting board 10.

Such upper surface 2 of first member 1 has a first predetermined size for holding such food product to be cut. Bottom surface 4 of first member 1 has a second predetermined size wherein such second predetermined size is smaller that the first predetermined size. By having the second surface 4 being smaller that such first surface 2, a lip or groove 16 is formed in the first member 1 on the bottom surface 4. This lip 16 permits the cutting board 10 to rest securely on a support member when such legs 32 are detached from the cutting board 10.

Such cutting board 10 further includes a means, generally designated 20, for allowing the juices from the food products being cut to drain from the cutting board 10. Such means 20 may include a plurality of apertures 12 which are disposed closely adjacent an outer edge of the first member 1. Such means 20 may also include a larger aperture 14 disposed at one end of the first member 1.

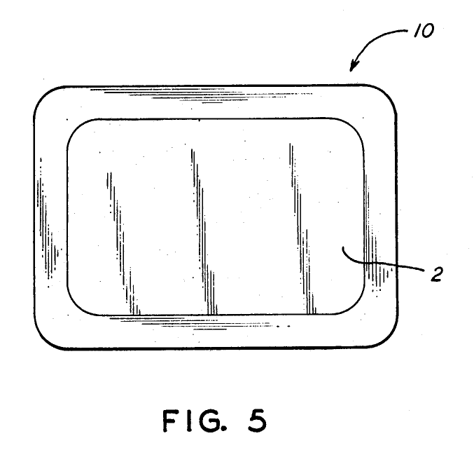

In an alternate embodiment of the invention, as seen in FIG. 5, such means 20 does not include apertures but the cutting board is sized such as to fit completely inside a drip pan (not shown) wherein the juices from the food products being cut can just drain over the edges of cutting board 10 and drain into the larger drip pan.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. A cutting board comprising:
(a) a first member having a predetermined shape and a predetermined thickness and formed from a predetermined material, said predetermined material having sufficient cut resistant properties and heat resistant properties for cutting at least one of hot and cold food products thereon and sufficient strength to support such food products to be cut;
(b) an upper surface of said first member having a first predetermined size for holding such food products to be cut;
(c) a bottom surface of said first member having a second predetermined size; and
(d) a predetermined plurality of legs engageable with said first member adjacent said bottom surface for supporting said first member.

2. The cutting board, according to claim 1, wherein said first member further includes a means for allowing juices from such food products to be cut to drain from said cutting board.

3. The cutting board, according to claim 2, wherein said means for allowing juices to drain from said cutting board includes a plurality of apertures formed through said first member.

4. The cutting board, according to claim 2, wherein said means for allowing juices from such food products to drain from said cutting board is a size differential between said cutting board and a pan into which said cutting board is placed, said cutting board being smaller than said pan which permits juices from such products to drain into such pan.

5. The cutting board, according to claim 1, wherein said predetermined shape of said cutting board is substantially rectangular.

6. The cutting board, according to claim 1, wherein said plurality of legs are at least three.

7. The cutting board, according to claim 7, wherein said plurality of legs are four.

8. The cutting board, according to claim 7, wherein said legs are closely adjacent four corners of said substantially rectangular cutting board.

9. The cutting board, according to claim 1, wherein said first predetermined material is selected from a group consisting of high density polyethylene, polypropylene and wood.

10. The combination, according to claim 9, wherein said wood includes laminated wood and ingrained wood.

11. The cutting board according to claim 1, wherein said plurality of legs are detachable from said first member.

12. The cutting board according to claim 11, wherein said first member has threaded openings into said bottom surface for attachment of said plurality of legs.

13. The cutting board according to claim 12, wherein said plurality of legs are attachable to said bottom surface of said first member by means of threads disposed on one end of said legs.

14. The cutting board according to claim 1, wherein said plurality of legs further include a non-skid surface disposed on unattached ends of said plurality of legs.

15. The cutting board according to claim 14, wherein said non-skid surface is formed as a cap over said unattached ends of said plurality of legs.

16. The cutting board according to claim 14, wherein said non-skid surface is formed from a resilient material.

17. The cutting board according to claim 16, wherein said resilient material is rubber.

18. The cutting board according to claim 1, wherein said said plurality of legs are made of said first predetermined material.
